(19) United States
(12) Patent Application Publication
(10) Pub. No.: US 2024/0256798 A1
(43) Pub. Date: Aug. 1, 2024

(54) AUTOMATED TRANSLATION OF MESSAGES WITHIN A GROUP COMMUNICATION SESSION

(71) Applicant: Zoom Video Communications, Inc., San Jose, CA (US)

(72) Inventor: Xiaolong Cai, San Jose, CA (US)

(21) Appl. No.: 18/104,146

(22) Filed: Jan. 31, 2023

(51) Int. Cl. G06F 40/58; H04L 51/046

(52) U.S. Cl. CPC G06F 40/58; H04L 51/046

(57) ABSTRACT

Methods and systems provide for automated translation of messages within a group communication session. In one embodiment, the system displays, at a client device associated with a user, a user interface (“UI”) for a group communication session, the UI including a display section for receiving chat messages associated with a plurality of participants of the group communication session; receives a number of chat messages sent by at least a subset of the participants; determines one or more conversational contexts between two or more participants of the group communication session; determines, based on at least one of the conversational contexts, at least one target language for translation; and upon receiving each of the initial chat messages: determines a source language for the initial chat message; determines whether there is a match between the source language for the initial chat message and the at least one target language; if there is no match, translates, in real-time, the initial chat message into the at least one target language; and displays, at the client device, the translated chat message within the display section of the UI.

### FIELD OF INVENTION

Various embodiments relate generally to digital communication, and more particularly, to systems and methods providing for the automated translation of messages within a group communication session.

### SUMMARY

The appended claims may serve as a summary of this application.

### BRIEF DESCRIPTION OF THE DRAWINGS

The present invention relates generally to digital communication, and more particularly, to systems and methods providing for the automated translation of messages within a group communication session.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of a communication interface within a chat platform displayed on a client device, in accordance with some embodiments.

FIG. 3B is a diagram illustrating one example embodiment of translating messages from a source language into a target language, in accordance with some embodiments.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Digital communication tools and platforms have been essential in providing the ability for people and organizations to communicate and collaborate remotely, e.g., over the internet. Applications for casual friendly conversation (“chat”), work meetings or gatherings, asynchronous work or personal conversation, and more have exploded in popularity. Many allow for participants to enter a conversation using any of a wide variety of devices and allow for switching between different devices in the middle of a conversation. It has also become common for such applications to allow for documents and media (such as images, video, or audio) to be uploaded to a server, where they can then be transmitted to other chat participants.

Due to the often global nature of remote work, in some remote communication sessions, participants may come from all over the world and speak or type in different languages with varying levels of fluency. While there is some shared language expected to be written or spoken within a meeting where a translator is not present, there are often significant communication barriers where that shared language is not a speaker's native language. Some participants would still greatly prefer to speak or type their native language and have some automated translation be performed. Even beyond that, it may be the case within a chat session that the participants are not aware of which participants are capable of typing or understanding which written languages. In other words, there may be not only a language barrier, but a knowledge barrier in terms of which participants have language barriers and which don't for various languages.

Thus, there is a need in the field of digital communication tools and platforms to create a new and useful system and method for the automated translation of messages within a group communication session. The source of the problem, as discovered by the inventors, is a lack of ability to automatically translate chat messages into a language that a user understands, taking into account information and conversational contexts about what the user understands and what the user does not.

In one embodiment, the system displays, at a client device associated with a user, a user interface (“UI”) for a group communication session, the UI including a display section for receiving chat messages associated with a plurality of participants of the group communication session; receives a number of chat messages sent by at least a subset of the participants; determines one or more conversational contexts between two or more participants of the group communication session; determines, based on at least one of the conversational contexts, at least one target language for translation; and upon receiving each of the initial chat messages: determines a source language for the initial chat message; determines whether there is a match between the source language for the initial chat message and the at least one target language; if there is no match, translates, in real-time, the initial chat message into the at least one target language; and displays, at the client device, the translated chat message within the display section of the UI.

Further areas of applicability of the present disclosure will become apparent from the remainder of the detailed description, the claims, and the drawings. The detailed description and specific examples are intended for illustration only and are not intended to limit the scope of the disclosure.

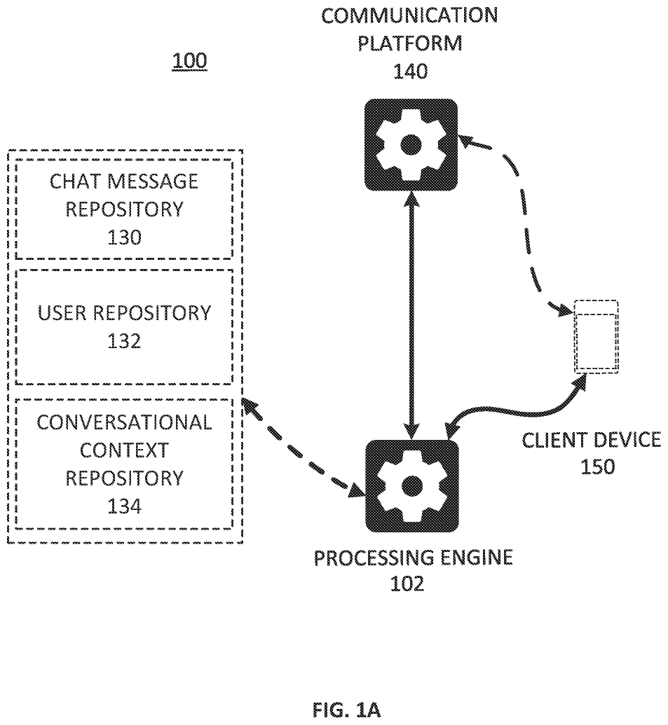

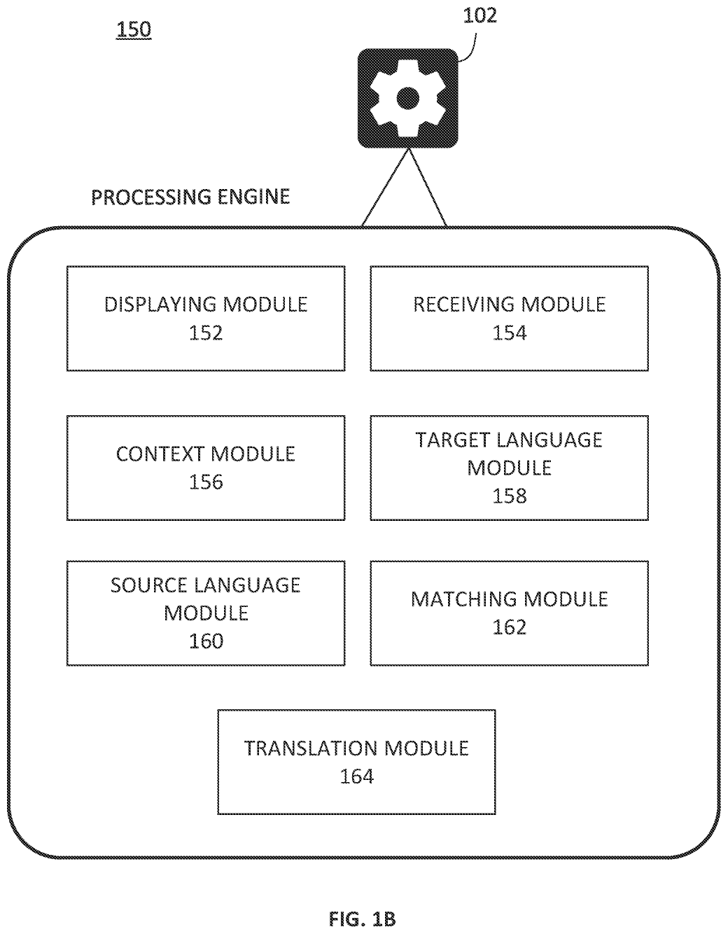

FIG. 1A is a diagram illustrating an exemplary environment in which some embodiments may operate. In the exemplary environment 100, a client device 150, one or more additional client device(s) 160, and a processing device 140 are connected to a processing engine 102 for a communication platform and a processing device 140 for a shared space intended for hosting a communication session maintained by the communication platform. The processing engine 102 is optionally connected to one or more repositories and/or databases. Such repositories and/or databases may include, for example, a chat message repository 130, a user repository 132, and a conversational context repository 134. One or more of such repositories may be combined or split into multiple repositories. The client device 150 and additional client device(s) 160 in this environment may be computers, and the processing device 140 and processing engine 102 may be, in whole or in part, applications or software hosted on a computer or multiple computers which are communicatively coupled via remote server or locally.

The exemplary environment 100 is illustrated with only one client device associated with a participant, one additional client device for another participant, one processing engine, and one processing device, though in practice there may be more or fewer additional client devices, processing engines, and/or processing devices. In some embodiments, the client device, additional client device(s), processing engine, and/or processing device may be part of the same computer or device.

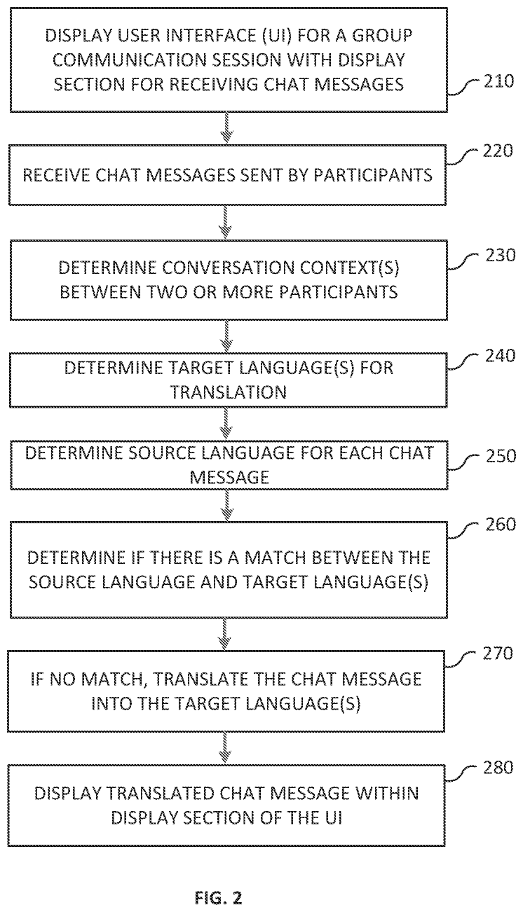

In an embodiment, the processing engine 102 may perform the method 200 (FIG. 2) or other method herein and, as a result, provide for the automated translation of messages within a group communication session. In some embodiments, this may be accomplished via communication with the client device, additional client device(s), processing engine 102, processing device 140, and/or other device(s) over a network between the device(s) and an application server or some other network server. In some embodiments, one or both of the processing engine 102 and processing device 140 may be an application, browser extension, or other piece of software hosted on a computer or similar device, or in itself a computer or similar device configured to host an application, browser extension, or other piece of software to perform some of the methods and embodiments herein.

In some embodiments, client device 150, processing device 140 and additional client device(s) 160 may each be devices with a display configured to present information to a user of the device. In some embodiments, the client device 150 and additional client device(s) 160 present information in the form of a user interface (UI) with UI elements or components. In some embodiments, the client device 150, the processing device 140 and receiving client device(s) 160 send and receive signals and/or information to the processing engine 102 pertaining to the communication platform. In some embodiments, client device 150 and additional client device(s) 160 are computer devices capable of hosting and executing one or more applications or other programs capable of sending and/or receiving information. In some embodiments, the client device 150 and/or additional client device(s) 160 may be a computer desktop or laptop, mobile phone, virtual assistant, virtual reality or augmented reality device, wearable, or any other suitable device capable of sending and receiving information. In some embodiments, the processing engine 102 and/or processing device 140 may be hosted in whole or in part as an application or web service executed on the client device 150 and/or additional client device(s) 160. In some embodiments, one or more of the communication platform 140, processing engine 102, and client device 150 or additional client device(s) 160 may be the same device. In some embodiments, the processing device 140 and/or the client device 150 and additional client device(s) 160 are associated with one or more particular user accounts.

In some embodiments, optional repositories function to store and/or maintain, respectively, chat messages received from participants within the group communication session, user information and preferences for the participants within the shared space; and conversational contexts between participants of the group communication session, as will be described in further detail below. The optional repositories may also store and/or maintain any other suitable information for the processing engine 102 to perform elements of the methods and systems herein pertaining to the communication platform. In some embodiments, the optional database(s) can be queried by one or more components of system 100 (e.g., by the processing engine 102), and specific stored data in the database(s) can be retrieved.

The communication platform is a platform configured to facilitate communication between two or more parties, such as within a conversation, “chat” (i.e., a chat room or series of public or private chat messages), video conference or meeting, message board or forum, virtual meeting, or other form of digital communication.

FIG. 1B is a diagram illustrating an exemplary computer system 150 with software modules that may execute some of the functionality described herein. In some embodiments, the modules illustrated are components of the processing engine 102.

Displaying module 152 functions to display, at a client device associated with a user, a UI for a group communication session, the UI including a display section for receiving chat messages associated with a number of participants of the group communication session; and also displays translated chat messages within the display section of the UI.

Receiving module 154 functions to receive a number of chat messages sent by at least a subset of the participants.

Context module 156 functions to determine one or more conversational contexts between two or more participants of the group communication session.

Target language model 158 functions to determine, based on at least one of the conversational contexts, at least one target language for translation.

Source language module 160 functions to, upon receiving each of the initial chat messages, determine a source language for the initial chat message.

Matching module 162 functions to determine whether there is a match between the source language for the initial chat message and the at least one target language.

Translation module 164 functions to translate in real-time, if there is no match, the initial chat message into the at least one target language; and displays, at the client device, the translated chat message within the display section of the UI.

FIG. 2A is a flow chart illustrating an exemplary method that may be performed in some embodiments.

At step 210, the system displays, at a client device associated with a user, a UI for a group communication session, the UI including a display section for receiving chat messages associated with a number of participants of the group communication session.

In some embodiments, the group communication session is any communication session which is hosted or maintained on within a communication platform, and which includes a number of participants such that it is more than just a one-to-one session and involves more than two people conversing with each other. In various embodiments, the “more than two people” may refer to more than two participants, more than two invitees to the session, more than two confirmed attendees, or more than two users of the communication platform. As used herein, “group” may variously refer to more than two such participants, attendees, invitees, and/or users.

In various embodiments, the group communication session may be one or more of: chat-based, video-based, image-based, and/or audio-based.

In some embodiments, the group communication session is a channel maintained on a communication platform. In some embodiments, a target language may be prespecified for all chat messages received within the channel. For example, a group channel marked “Marketing Team—English” may be available for one or more members of a marketing team to join. This group channel may be configured such that English is always designated as a target language to be used for translating chat messages. Target languages and translation will be described in further detail below.

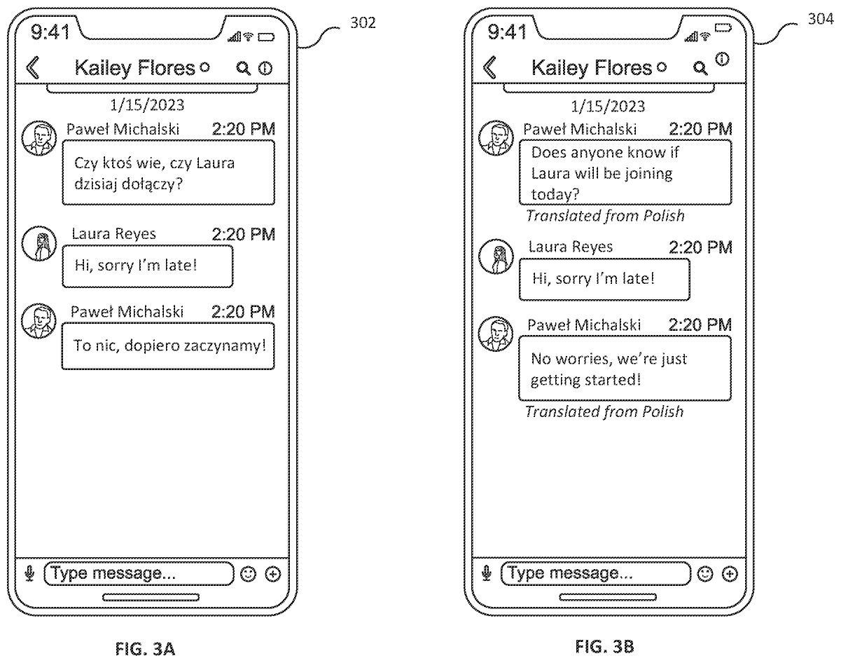

In some embodiments, the UI relates to the communication platform, and may represent a “chat window”, such as a window within a GUI that displays a conversation between that user account and one or more other user accounts. The communication interface includes at least a first input section for receiving submitted chat messages associated with a user account, and a display section for displaying message information received by the user account from other user accounts. One example of a communication interface within a communication platform is illustrated in FIG. 3A, which is described in further detail below.

At step 220, the system receives a number of chat messages sent by at least a subset of the participants.

In some embodiments, the chat messages may be textual. In some embodiments, the chat messages may be a mix of textual and non-textual elements. The chat messages may include, for example, emojis, icons, voice-to-text transcription, text-to-voice audio content, any other audio content, image content, video content, audiovisual content, or any other suitable form or method of digital communication or sending of data. In some embodiments, various graphical user interface (“GUI”) elements may appear in different contexts to facilitate the input of the chat messages, such as, e.g., a pop-up virtual keyboard. In some embodiments, as the user types the message into the chat window, the system concurrently parses the message in order to detect any sensitive information, as will be described in further detail below.

The display section functions to provide a way for the user associated with the client device to receive incoming messages from other users who are privy to the conversation or chat window. In some embodiments, one or more GUI elements may appear to provide some notification that a new message has appeared within the conversation.

In some embodiments, the communication interface first authenticates the user account and/or client device as legitimate and authorized prior to displaying the communication interface. Authentication may be provided via one or more first party or third party authentication tools. Such authentication processes or techniques may include, e.g., multi-factor authentication (MFA), OAuth, OpenID Connect, SAML 2.0, a password, an RSA SecurID token, integrated authentication using a directory service, a client certificate, any other form of authentication, or a combination thereof. In some embodiments, a secondary login may be required other than a user's primary user account which requires separate authentication for purposes of sending sensitive messages. In some embodiments, one or more access control components or techniques may be provided for regulating access of the user account to various features. In some embodiments, access logging may be implemented in various ways. In some embodiments, a timeline or other document may be automatically generated with respect to a user account during or after the authentication process.

In some embodiments, multiple chat messages are sent from multiple participants within the group communication session. The chat messages may potentially be sent from the participants in a single language or in multiple different languages. In some embodiments, the chat messages may appear, as displayed within the communication interface at the client device, in a single language or in multiple different languages.

At step 230, the system determines one or more conversational contexts between two or more participants of the group communication session. A “conversational context”, as used herein, may refer to some piece of contextual information about the conversation, participants within the conversation, and/or languages being used within the conversation which may be determined by the system as a result of the chat messages that have been sent within the conversation. This contextual information may be any information which is relevant for the translation of messages appearing within the chat window for the user at the client device. In some embodiments, conversational contexts may be determined based on one or more “side conversations” between participants within the group chat. For example, during a marketing team meeting, Jerry and Dana may briefly chat about the recent weather in the city they both live in. Conversational context between Jerry and Dana may be determined based on such meetings.

In some embodiments, the conversational context may be determined not solely from the chat messages between the participants engaged in conversation, but also by additional pieces of information. Such additional pieces of information may be, e.g., profile data about the user, such as preferred languages of the user, profile data about one or more of the participants engaged in conversation, other pieces of conversational context the system has determined for this group communication session, or other pieces of conversational context the system has determined in previous communication sessions.

In some embodiments, at least one of the conversational contexts relates to a language shared between the participants in the conversational context, the user being one of the participants in the conversational context. For example, the user at the client device may receive a chat message from one of the participants, and may then respond to that message by submitting a chat message to appear within the group chat session. If both of these messages share a single language, then that may be a piece of conversational context that the system determines. For example, one or more conversational contexts determined by the system may be, e.g., that both the user and the other participant are conversant in Spanish; that the other participant sent the first chat message in Spanish, and the user at the client device responded to that chat message in Spanish; and any other relevant pieces of context which may be determined as a result of the conversation.

In some embodiments, at least one of the conversational contexts relates to a language shared between the participants in the conversational context, the user being different from the participants in the conversational context. For example, a conversation within the group communication session may occur between two participants, Anna and Lauren, while the user at the client device reads their messages but does not participate. Anna may be sending her messages in English, while Lauren may be sending her messages in French. The conversational context may include, for example, context that Anna's preferred language in this group session is English, Lauren's preferred language in this group session is in French, that Anna and the user at the client device share a preferred language of English, that Lauren and the user at the client device do not share a preferred language but that Lauren understands some English, or any other conversational context which the system may determine based on the two participants engaging in a conversation that the user does not participate in.

In some embodiments, at least one of the conversational contexts is inferred from one or more of: chat messages, audio messages, or video messages between two or more of the participants in the group communication session. In some embodiments, the group communication session may involve a combination of communication modalities which are employed by the participants. For example, a group chat session may include both chat messages being sent and audio being spoken by participants, or a group chat session may use a combination of chat messages, audio, and video. In some embodiments, conversational context may be gleaned as a result of audio and/or video context from the participants in the session, not solely chat messages. For example, Anna may send chat messages in English but may speak Spanish and French to other participants vocally, which may be detected by the system within the audio stream of her speaking. Conversational contexts may thus be determined regarding Anna's preferences or abilities for text chat messages as well as spoken language. In another example, a participant may demonstrate understanding of another participant's written language, but inability or unwillingness to speak that language. Such conversational context about the participant's preferences and abilities may be inferred from a combination of spoken utterances and written chat messages by that participant and one or more other participants.

At step 240, the system determines, based on at least one of the conversational contexts, at least one target language for translation. Upon determining the one or more conversational contexts within the group communication session, the system may determine a target language based on the contexts and data determined by or received by the system. For example, the system may determine a target language of English for a particular user, based on one or more previous conversational contexts that indicate the user overwhelmingly sends chat messages in English, that the user has only sent chat messages in Spanish in less than 5% of known chat-based conversations, and that most of the participants within the group communication session are at least somewhat conversant in written English. In another example, the system may determine a target language of German based on data and contexts that the user has written chat messages in both German and English, 75% of other participants in the session primarily speak and write German, and that no users in the session have written or spoken English in the session thus far. In some embodiments, the system is capable of inferring one or more pieces of information from multiple pieces of data to find the target translation language that will lead to one or more of, e.g., the least difficulty in understanding for the user; the least amount of translations needed to be performed within the group communication session; the language understood by the most amount of other participants in addition to the user at the client device; or any other suitable objective for selecting a target language.

In some embodiments, determining at least one target language for translation is further based on one or more preconfigured user preferences. In some embodiments, the user may have selected one or more language-related preferences, such as, for example, within a settings UI or other subsection of the UI, or an option selected by the user prior to or during the communication session. In some embodiments, the user may select more than one language preferences. For example, the user may select preferred languages of both Italian and English. Both of these language may be given special weight or consideration by the system as it determines a target language. In some embodiments, multiple target languages may be chosen. For example, the system may determine that both Italian and English should be target languages for translation within a group communication session, given user preferences as well as conversational contexts that have been determined within the communication session.

In some embodiments, determining the at least one target language for translation is further based on one or more inferred user preferences. That is, in some situations, the system may determine the target language(s) based on one or more pieces of information the system has learned or inferred about the user via, e.g., demonstrated understanding of and/or facility with written and/or spoken languages in the current communication session and past group communication sessions, transcripts of past conversations, known conversational contexts both past and present, user preferences, and more. In some embodiments, at least one of the inferred user preferences is inferred from analyzing one or more of: transcripts of past conversations, and determined conversational contexts of past group communication sessions.

At step 250, upon receiving each of the initial chat messages, the system determines a source language for the initial chat message. In some embodiments, determining the source language may be performed by the system via one or more Application Programming Interfaces (“APIs”), software libraries, or frameworks which are capable of detecting a language based on a given section of text. In some embodiments, such APIs, software libraries, or frameworks may be first party language detection systems designed for use within the communication platform, or third party language detection systems which have been integrated into the communication platform. In some embodiments, the system may be incapable of determining a source language for the initial chat message. In this case, it may opt to not perform translation of the chat message. In some embodiments, a notification may appear within the UI informing the user of this inability to translate the message.

At step 260, the system determines whether there is a match between the source language for the initial chat message and the at least one target language. That is, in some embodiments, the system will determine if the source language for the initial chat message already matches one of the target languages that were determined in step 240. If there is a match, then in some embodiments, the system does not translate the initial chat message. In some embodiments, the system will translate the initial chat message into one or more target languages other than the matching target language. This may be done, for example, if the system has received information or conversational contexts indicating that one of the non-matching target languages is more preferred than the matching target language, or if the user has requested multiple languages to be displayed simultaneously.

At step 270, if there is no match, the system translates, in real-time, the initial chat message into the at least one target language. That is, if the source language of the initial chat session does not match any of the target language, then the system will proceed with translating the initial chat message from the source language to at least one of the target languages. In some embodiments, the translating is performed via a translation API associated with a communication platform which maintains the group communication session, a third-party translation API, one or more software libraries for translation, one or more translation frameworks, or some combination thereof.

In some embodiments where the group communication session is a chat channel, for each received chat message, one translation is performed for all participants within the channel. In some embodiments, a target language is designated or prespecified for all chat messages received within the channel. For example, a group channel marked “Marketing Team—English” may be available for one or more members of a marketing team to join. This group channel may be configured such that English is always designated as a target language to be used for translating chat messages. When a chat message is submitted by a participant to the group communication session, the system predetermines that the target language is the one specified for that channel, e.g. English. If the source language does not match the predetermined target language, then the system performs a translation of the message into the predetermined target language. Rather than performing a translation of the message separately for each participant within the channel, only one translation is performed, then that translated message is propagated for display at the client devices associated with the participants in the channel.

At step 280, the system displays, at the client device, the translated chat message within the display section of the UI. In some embodiments, the system will display the translated chat message in such a way that it replaces the text of the initial chat message that was in the original source language. In some embodiments, the original text can remain on display while the translated text is displayed above or below the original text. In some embodiments, an additional notification appears adjacent to or in proximity to message, indicated that the message was translated from the source language. For example, the notification may read “Translated from Spanish” and may appear below the text of the chat message. In some embodiments, the notification may additionally indicate which language it was translated into. In some embodiments, the user may be able to interactively select a different language to translate the initial chat message into. In some embodiments, language translation options may be populated for the user from the user's preferred languages or languages that the user is inferred to understand or be conversant in. In some embodiments, the user may be allowed to interactively toggle back and forth between the content of the message in the original source language and the text language translation. In some embodiments, the user may be allowed to interactively toggle between the text in multiple preferred language translations as well as the original source language.

In some embodiments, the system determines two or more target languages, and the two or more target languages are displayed simultaneously for each of the translated chat messages that are displayed. For example, if a particular user has written both English and French within chat messages in past group chat sessions, then the system will infer that the user is conversant in both. and may automatically provide translations in both languages simultaneously within the UI displayed at the client device.

In some embodiments, the system determines two or more target languages, and any of the two or more target languages may be displayed for each of the translated chat messages based on the setting of a language toggle UI element. For example, the user that is determined to be conversant in both English and French may initially see English, as the system has determined that the user's predominantly used language is English, and the system may also provide, e.g., a toggle button or link that may be interacted with to toggle between English and French.

In some embodiments, the system displays, on one or more additional client devices associated with one or more of the participants other than the user, a notification that chat messages sent to the user are being translated into the at least one target language. For example, upon the user seeing translated messages displayed in a target language, the senders of those translated messages may receive a notification or see a message displayed within their UIs that the user is reading the message translated into the target language. In some embodiments, one or more participants (e.g., senders and/or the user who is viewing translated messages) may enable or disable such a notification by modifying their user preferences accordingly.

In some embodiments, the system displays, at an additional client device associated with a sending participant of the chat message, the translated chat message in the target language. That is, in some embodiments, the sender of the chat message that has been translated may also be able to view the translation. This may be useful in some cases where a participant can read both languages and wishes to ensure that the translation is accurate or wishes to determine whether some miscommunication in the conversation can be resolved.

In some embodiments, the system displays, at the client device, the chat message as originally sent alongside the translated chat message within the display section of the UI. For example, the system can simultaneously display, at the client device, both the initial chat message in the original source language, and the message as translated into at least one target language. This provides users reading the translated message with the ability to see the original as well, which can prove useful for a variety of reasons, such as, e.g., language learning and acquisition, verification of content accuracy, or other potential reasons.

In some embodiments, upon the group communication session being terminated, the system provides a UI for the user to review a transcript of the translated chat messages within the group communication session. This allows the user to be able to review translations of the messages after the session has ended. In some embodiments, the system generates a version of the transcript with translations of various chat messages from their source language into one or more target languages. This may allow various users to, for example, study translated messages at some length when the user finds them difficult to understand or wishes to learn the source language, or wishes to return to group conversations to review them.

In some embodiments, upon the group communication session being terminated, the system provides, at the client device, a UI for the user to request translation of the chat messages from the group communication session into one or more additional languages different from the at least one target language; translates the chat messages from the group communication session into the one or more additional languages; and displays, at the client device, a transcript of the translated chat messages in the one or more additional languages within the group communication session. During review of a group communication session after the session has ended, a user may wish to review a transcript of the session in a particular language that the user did not have access to while the communication session was still ongoing. For example, a user may read messages in a group communication session that have automatically been translated into English. After the meeting is over, the user may then wish to read the same messages in the user's non-English native language.

FIG. 3A is a diagram illustrating one example embodiment of a communication interface within a chat platform displayed on a client device, in accordance with some embodiments.

Within the example embodiment, a user interface is displayed on a client device 302 that is being operated by a user. The user interface displays a group communication session, specifically a group chat session which is maintained on a communication platform. Within the group chat session, different participants are shown along with chat messages they have sent in the session and which have been displayed at the user's client device 302. The participants that are shown within the example include Paweł Michalski, Laura Reyes, and the user associated with the client device 302, Kailey Flores. The chat messages sent from Paweł Michalski appear in Polish, as that is the original source language this participant wrote the message in. In this example, no translation is being performed. Laura Reyes joins the group communication session and sends a message in English, which is replied to in Polish. It may be possible that one or both of these participants has been provided with an auto-translation of the received messages into their target language of choice, so although this conversation appears to be conducted in two different languages, each participant may see the messages only in their preferred language(s). Regarding the user, the lack of translations may potentially be a result of the user opting to disable translation services, or the system not yet performing any automatic translations as it does not yet have any conversational contexts to determine a target language to translate the messages into.

FIG. 3B is a diagram illustrating one example embodiment of translating messages from a source language into a target language, in accordance with some embodiments.

This example embodiment shows the same group communication session and same messages being displayed on the same client device 304 as in FIG. 3A, but instead of messages not being translated for the user, the messages are now translated into the user's target language, which is English. In some embodiments, the system may have determined that the user's target language for messages to be translated into is English based on one or more pieces of information, for example: transcripts of previous communication sessions in which the user sent English messages; the conversational context of the side conversation between Paweł and Laura, which the system used to infer that Laura uses English, and that Paweł may understand English but not be able to communicate fluently in English; and previous conversational context the system has used to infer that the user does not understand Polish. In some embodiments, the system may thereafter perform one translation of the messages from Polish into English, then propagate those translations to both Laura and the user, as well as any other participants whose target language for translation is determined to be English.

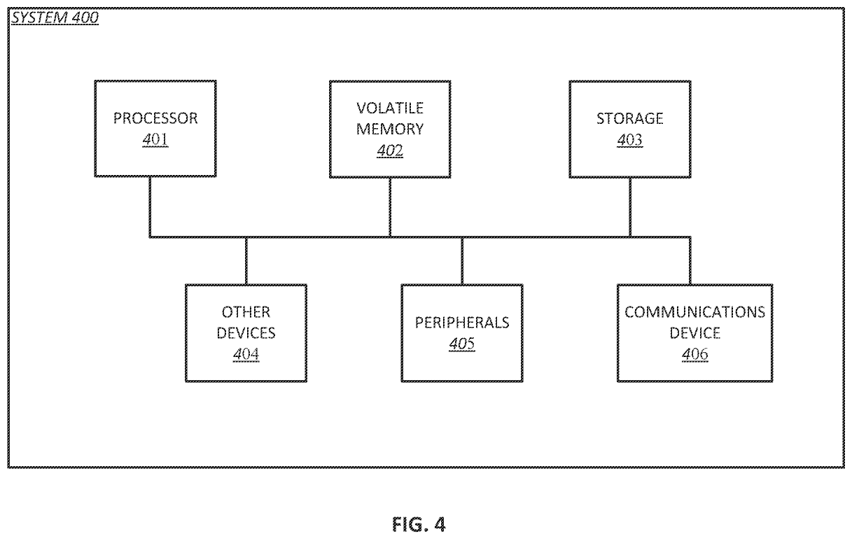

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

It will be appreciated that the present disclosure may include any one and up to all of the following examples.

Example 1. A method, comprising: displaying, at a client device associated with a user, a user interface (UI) for a group communication session, the UI comprising a display section for receiving chat messages associated with a plurality of participants of the group communication session; receiving a plurality of chat messages sent by at least a subset of the plurality of participants; determining one or more conversational contexts between two or more participants of the group communication session; determining, based on at least one of the conversational contexts, at least one target language for translation; and upon receiving each of the initial chat messages: determining a source language for the initial chat message; determining whether there is a match between the source language for the initial chat message and the at least one target language; if there is no match, translating, in real-time, the initial chat message into the at least one target language; and displaying, at the client device, the translated chat message within the display section of the UI.

Example 2. The method of example 1, wherein the group communication session is one or more of: chat-based, video-based, and audio-based.

Example 3. The method of any of examples 1-2, wherein at least one of the conversational contexts relates to a language shared between the participants in the conversational context, the user being one of the participants in the conversational context.

Example 4. The method of any of examples 1-3, wherein at least one of the conversational contexts relates to a language shared between the participants in the conversational context, the user being different from the participants in the conversational context.

Example 5. The method of any of examples 1-4, wherein at least one of the conversational contexts is inferred from one or more of: chat messages, audio messages, or video messages between two or more of the participants in the group communication session.

Example 6. The method of any of examples 1-5, wherein determining the at least one target language for translation is further based on one or more preconfigured user preferences.

Example 7. The method of any of examples 1-6, wherein determining the at least one target language for translation is further based on one or more inferred user preferences.

Example 8. The method of example 7, wherein at least one of the inferred user preferences is inferred from analyzing one or more of: transcripts of past conversations, and determined conversational contexts of past group communication sessions.

Example 9. The method of any of examples 1-8, wherein the group communication session is a channel maintained on a communication platform, a target language being prespecified for all chat messages received within the channel.

Example 10. The method of example 9, wherein for each received chat message, one translation is performed for all participants within the channel.

Example 11. The method of any of examples 1-10, wherein the at least one target language comprises two or more target languages, and wherein the two or more target languages are displayed simultaneously for each of the translated chat messages that are displayed.

Example 12. The method of any of examples 1-11, wherein the at least one target language comprises two or more target languages, and wherein any of the two or more target languages may be displayed for each of the translated chat messages based on the setting of a language toggle UI element.

Example 13. The method of any of examples 1-12, further comprising: displaying, on one or more additional client devices associated with one or more of the participants other than the user, a notification that chat messages sent to the user are being translated into the at least one target language.

Example 14. The method of any of examples 1-13, further comprising: displaying, at an additional client device associated with a sending participant of the chat message, the translated chat message in the target language.

Example 15. The method of any of examples 1-14, further comprising: displaying, at the client device, the chat message as originally sent alongside the translated chat message within the display section of the UI.

Example 16. The method of any of examples 1-15, wherein the translating is performed via one or more of: a translation Application Programming Interface (API) associated with a communication platform which maintains the group communication session, and a third-party translation API.

Example 17. The method of any of examples 1-16, further comprising: upon the group communication session being terminated, providing a UI for the user to review a transcript of the translated chat messages within the group communication session.

Example 18. The method of any of examples 1-17, further comprising: upon the group communication session being terminated, providing, at the client device, a UI for the user to request translation of the chat messages from the group communication session into one or more additional languages different from the at least one target language; translating the chat messages from the group communication session into the one or more additional languages; and displaying, at the client device, a transcript of the translated chat messages in the one or more additional languages within the group communication session.

Example 19. A communication system comprising one or more processors configured to perform the operations of: displaying, at a client device associated with a user, a user interface (UI) for a group communication session, the UI comprising a display section for receiving chat messages associated with a plurality of participants of the group communication session; receiving a plurality of chat messages sent by at least a subset of the plurality of participants; determining one or more conversational contexts between two or more participants of the group communication session; determining, based on at least one of the conversational contexts, at least one target language for translation; and upon receiving each of the initial chat messages: determining a source language for the initial chat message; determining whether there is a match between the source language for the initial chat message and the at least one target language; if there is no match, translating, in real-time, the initial chat message into the at least one target language; and displaying, at the client device, the translated chat message within the display section of the UI.

Example 20. The communication system of example 19, wherein the group communication session is one or more of: chat-based, video-based, and audio-based.

Example 21. The communication system of any of examples 19-20, wherein at least one of the conversational contexts relates to a language shared between the participants in the conversational context, the user being one of the participants in the conversational context.

Example 22. The communication system of any of examples 19-21, wherein at least one of the conversational contexts relates to a language shared between the participants in the conversational context, the user being different from the participants in the conversational context.

Example 23. The communication system of any of examples 19-22, wherein at least one of the conversational contexts is inferred from one or more of: chat messages, audio messages, or video messages between two or more of the participants in the group communication session.

Example 24. The communication system of any of examples 19-23, wherein determining the at least one target language for translation is further based on one or more preconfigured user preferences.

Example 25. The communication system of any of examples 19-24, wherein determining the at least one target language for translation is further based on one or more inferred user preferences.

Example 26. The communication system of example 25, wherein at least one of the inferred user preferences is inferred from analyzing one or more of: transcripts of past conversations, and determined conversational contexts of past group communication sessions.

Example 27. The communication system of any of examples 19-26, wherein the group communication session is a channel maintained on a communication platform, a target language being prespecified for all chat messages received within the channel.

Example 28. The communication system of example 27, wherein for each received chat message, one translation is performed for all participants within the channel.

Example 29. The communication system of any of examples 19-28, wherein the at least one target language comprises two or more target languages, and wherein the two or more target languages are displayed simultaneously for each of the translated chat messages that are displayed.

Example 30. The communication system of any of examples 19-29, wherein the at least one target language comprises two or more target languages, and wherein any of the two or more target languages may be displayed for each of the translated chat messages based on the setting of a language toggle UI element.

Example 31. The communication system of any of examples 19-30, the one or more processors being further configured to perform the operation of: displaying, on one or more additional client devices associated with one or more of the participants other than the user, a notification that chat messages sent to the user are being translated into the at least one target language.

Example 32. The communication system of any of examples 19-31, the one or more processors being further configured to perform the operation of: displaying, at an additional client device associated with a sending participant of the chat message, the translated chat message in the target language.

Example 33. The communication system of any of examples 19-32, the one or more processors being further configured to perform the operation of: displaying, at the client device, the chat message as originally sent alongside the translated chat message within the display section of the UI.

Example 34. The communication system of any of examples 19-33, wherein the translating is performed via one or more of: a translation Application Programming Interface (API) associated with a communication platform which maintains the group communication session, and a third-party translation API.

Example 35. The communication system of any of examples 19-34, the one or more processors being further configured to perform the operation of: upon the group communication session being terminated, providing a UI for the user to review a transcript of the translated chat messages within the group communication session.

Example 36. The communication system of any of examples 19-35, the one or more processors being further configured to perform the operation of: upon the group communication session being terminated, providing, at the client device, a UI for the user to request translation of the chat messages from the group communication session into one or more additional languages different from the at least one target language; translating the chat messages from the group communication session into the one or more additional languages; and displaying, at the client device, a transcript of the translated chat messages in the one or more additional languages within the group communication session.

Example 37. A non-transitory computer-readable medium containing instructions, comprising: instructions for displaying, at a client device associated with a user, a user interface (UI) for a group communication session, the UI comprising a display section for receiving chat messages associated with a plurality of participants of the group communication session; instructions for receiving a plurality of chat messages sent by at least a subset of the plurality of participants; instructions for determining one or more conversational contexts between two or more participants of the group communication session; instructions for determining, based on at least one of the conversational contexts, at least one target language for translation; and instructions for, upon receiving each of the initial chat messages: determining a source language for the initial chat message; determining whether there is a match between the source language for the initial chat message and the at least one target language; if there is no match, translating, in real-time, the initial chat message into the at least one target language; and displaying, at the client device, the translated chat message within the display section of the UI.

Example 38. The non-transitory computer-readable medium of example 37, wherein the group communication session is one or more of: chat-based, video-based, and audio-based.

Example 39. The non-transitory computer-readable medium of any of examples 37-38, wherein at least one of the conversational contexts relates to a language shared between the participants in the conversational context, the user being one of the participants in the conversational context.

Example 40. The non-transitory computer-readable medium of any of examples 37-39, wherein at least one of the conversational contexts relates to a language shared between the participants in the conversational context, the user being different from the participants in the conversational context.

Example 41. The non-transitory computer-readable medium of any of examples 37-40, wherein at least one of the conversational contexts is inferred from one or more of: chat messages, audio messages, or video messages between two or more of the participants in the group communication session.

Example 42. The non-transitory computer-readable medium of any of examples 37-41, wherein determining the at least one target language for translation is further based on one or more preconfigured user preferences.

Example 43. The non-transitory computer-readable medium of any of examples 37-42, wherein determining the at least one target language for translation is further based on one or more inferred user preferences.

Example 44. The non-transitory computer-readable medium of example 43, wherein at least one of the inferred user preferences is inferred from analyzing one or more of: transcripts of past conversations, and determined conversational contexts of past group communication sessions.

Example 45. The non-transitory computer-readable medium of any of examples 37-44, wherein the group communication session is a channel maintained on a communication platform, a target language being prespecified for all chat messages received within the channel.

Example 46. The non-transitory computer-readable medium of example 45, wherein for each received chat message, one translation is performed for all participants within the channel.

Example 47. The non-transitory computer-readable medium of any of examples 37-46, wherein the at least one target language comprises two or more target languages, and wherein the two or more target languages are displayed simultaneously for each of the translated chat messages that are displayed.

Example 48. The non-transitory computer-readable medium of any of examples 37-47, wherein the at least one target language comprises two or more target languages, and wherein any of the two or more target languages may be displayed for each of the translated chat messages based on the setting of a language toggle UI element.

Example 49. The non-transitory computer-readable medium of any of examples 37-48, the one or more processors being further configured to perform the operation of: displaying, on one or more additional client devices associated with one or more of the participants other than the user, a notification that chat messages sent to the user are being translated into the at least one target language.

Example 50. The non-transitory computer-readable medium of any of examples 37-49, the one or more processors being further configured to perform the operation of: displaying, at an additional client device associated with a sending participant of the chat message, the translated chat message in the target language.

Example 51. The non-transitory computer-readable medium of any of examples 37-50, the one or more processors being further configured to perform the operation of: displaying, at the client device, the chat message as originally sent alongside the translated chat message within the display section of the UI.

Example 52. The non-transitory computer-readable medium of any of examples 37-51, wherein the translating is performed via one or more of: a translation Application Programming Interface (API) associated with a communication platform which maintains the group communication session, and a third-party translation API.

Example 53. The non-transitory computer-readable medium of any of examples 37-52, the one or more processors being further configured to perform the operation of: upon the group communication session being terminated, providing a UI for the user to review a transcript of the translated chat messages within the group communication session.

Example 54. The non-transitory computer-readable medium of any of examples 37-53, the one or more processors being further configured to perform the operation of: upon the group communication session being terminated, providing, at the client device, a UI for the user to request translation of the chat messages from the group communication session into one or more additional languages different from the at least one target language; translating the chat messages from the group communication session into the one or more additional languages; and displaying, at the client device, a transcript of the translated chat messages in the one or more additional languages within the group communication session.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
displaying, at a client device associated with a user, a user interface (UI) for a group communication session, the UI comprising a display section for receiving chat messages associated with a plurality of participants of the group communication session;
receiving a plurality of chat messages sent by at least a subset of the plurality of participants;
determining one or more conversational contexts between two or more participants of the group communication session;
determining, based on at least one of the conversational contexts, at least one target language for translation; and
upon receiving each of the initial chat messages:
determining a source language for the initial chat message;
determining whether there is a match between the source language for the initial chat message and the at least one target language;
if there is no match, translating, in real-time, the initial chat message into the at least one target language; and
displaying, at the client device, the translated chat message within the display section of the UI.

2. The method of claim 1, wherein the group communication session is one or more of: chat-based, video-based, and audio-based.

3. The method of claim 1, wherein at least one of the conversational contexts relates to a language shared between the participants in the conversational context, the user being one of the participants in the conversational context.

4. The method of claim 1, wherein at least one of the conversational contexts relates to a language shared between the participants in the conversational context, the user being different from the participants in the conversational context.

5. The method of claim 1, wherein at least one of the conversational contexts is inferred from one or more of: chat messages, audio messages, or video messages between two or more of the participants in the group communication session.

6. The method of claim 1, wherein determining the at least one target language for translation is further based on one or more preconfigured user preferences.

7. The method of claim 1, wherein determining the at least one target language for translation is further based on one or more inferred user preferences.

8. The method of claim 7, wherein at least one of the inferred user preferences is inferred from analyzing one or more of: transcripts of past conversations, and determined conversational contexts of past group communication sessions.

9. The method of claim 1, wherein the group communication session is a channel maintained on a communication platform, a target language being prespecified for all chat messages received within the channel.

10. The method of claim 9, wherein for each received chat message, one translation is performed for all participants within the channel.

11. The method of claim 1, wherein the at least one target language comprises two or more target languages, and wherein the two or more target languages are displayed simultaneously for each of the translated chat messages that are displayed.

12. The method of claim 1, wherein the at least one target language comprises two or more target languages, and wherein any of the two or more target languages may be displayed for each of the translated chat messages based on the setting of a language toggle UI element.

13. A communication system comprising one or more processors configured to perform the operations of:
displaying, at a client device associated with a user, a user interface (UI) for a group communication session, the UI comprising a display section for receiving chat messages associated with a plurality of participants of the group communication session;
receiving a plurality of chat messages sent by at least a subset of the plurality of participants;
determining one or more conversational contexts between two or more participants of the group communication session;
determining, based on at least one of the conversational contexts, at least one target language for translation; and
upon receiving each of the initial chat messages:
determining a source language for the initial chat message;
determining whether there is a match between the source language for the initial chat message and the at least one target language;
if there is no match, translating, in real-time, the initial chat message into the at least one target language; and
displaying, at the client device, the translated chat message within the display section of the UI.

14. The communication system of claim 13, the one or more processors being further configured to perform the operation of:
displaying, on one or more additional client devices associated with one or more of the participants other than the user, a notification that chat messages sent to the user are being translated into the at least one target language.

15. The communication system of claim 13, the one or more processors being further configured to perform the operation of:
displaying, at an additional client device associated with a sending participant of the chat message, the translated chat message in the target language.

16. The communication system of claim 13, the one or more processors being further configured to perform the operation of:
displaying, at the client device, the chat message as originally sent alongside the translated chat message within the display section of the UI.

17. The communication system of claim 13, wherein the translating is performed via one or more of: a translation Application Programming Interface (API) associated with a communication platform which maintains the group communication session, and a third-party translation API.

18. The communication system of claim 13, the one or more processors being further configured to perform the operation of:
upon the group communication session being terminated, providing a UI for the user to review a transcript of the translated chat messages within the group communication session.

19. The communication system of claim 13, the one or more processors being further configured to perform the operation of:
upon the group communication session being terminated, providing, at the client device, a UI for the user to request translation of the chat messages from the group communication session into one or more additional languages different from the at least one target language;
translating the chat messages from the group communication session into the one or more additional languages; and
displaying, at the client device, a transcript of the translated chat messages in the one or more additional languages within the group communication session.

20. A non-transitory computer-readable medium containing instructions, comprising:
instructions for displaying, at a client device associated with a user, a user interface (UI) for a group communication session, the UI comprising a display section for receiving chat messages associated with a plurality of participants of the group communication session;
instructions for receiving a plurality of chat messages sent by at least a subset of the plurality of participants;
instructions for determining one or more conversational contexts between two or more participants of the group communication session;
instructions for determining, based on at least one of the conversational contexts, at least one target language for translation; and
instructions for, upon receiving each of the initial chat messages:
determining a source language for the initial chat message;
determining whether there is a match between the source language for the initial chat message and the at least one target language;
if there is no match, translating, in real-time, the initial chat message into the at least one target language; and
displaying, at the client device, the translated chat message within the display section of the UI.
